(19) United States
(12) Patent Application Publication
(10) Pub. No.: US 2026/0206887 A1
(43) Pub. Date: Jul. 23, 2026

(54) MEDICAL GARMENT

(71) Applicant: HTO - HIGH TECH OSTEOSYNTHESIS, S.A., Funchal (PT)

(72) Inventors: Giovanni PALMIERI, Napoli (IT); Giorgio GAINO, Località Saletto - Borgo Veneto PD (IT)

(73) Assignee: HTO - HIGH TECH OSTEOSYNTHESIS, S.A., Funchal (PT)

(21) Appl. No.: 19/138,225

(22) PCT Filed: Dec. 13, 2023
(86) PCT No.: PCT/IB2023/062582

§ 371 Date: Jun. 12, 2025

(30) Foreign Application Priority Data
Dec. 19, 2022 (PT) 118413

(51) Int. Cl. A41D 13/12

(52) U.S. Cl. CPC A41D 13/1218

(57) ABSTRACT

A medical garment for protecting a medical operator from contamination, having: an upper hood portion, configured to cover the user's head and to be worn above a surgical helmet; a lower gown portion configured to cover at least the user's torso; and a first intermediate connecting portion arranged between the hood portion and the gown portion, wherein the first connecting portion includes a torsionally deformable structure configured to ease the user's body rotation about a longitudinal axis.

### FIELD OF THE INVENTION

The present invention relates to a garment for use by medical personnel. In particular, the invention relates to a medical toga including a cap or hood, configured to be worn by a surgeon.

### BACKGROUND OF THE INVENTION

Over the past two decades, systems for protecting the head and face of healthcare workers during surgery or other medical activities have become very common. These systems generally include a helmet and a garment covering the operator's head and thus the helmet worn by him/her. The garment is usually equipped with a transparent vision shield, or lens, attached to the fabric of the hood. The lens is configured to fit over an open front frame of the helmet and acts as a face shield.

The above known-art garments can be in form of a hood, cape or cap, covering the head and shoulders only and thus intended to be worn together with a separate surgical gown fastened by strings. Alternatively, the garment can be a full toga, i.e. a single piece of clothing covering both the head and the torso, abdomen and thighs of the medical operator. The toga typically has a posterior closure, e.g. in form of a zip, to facilitate its wearing on and generally configured to hermetically seal the surgeon within the garment.

As mentioned, the protection system including the helmet plus the garment is generally worn by the healthcare worker during surgery, e.g. orthopaedic surgery, and offers superior performances with respect to masks and simple face shields because it covers the entire head of the operator, creating a sterile barrier between him/her and the patient.

In addition, the above system also offers valuable protection for the patient against contamination from the surgeon and other healthcare workers, as it prevents, e.g., hair, dandruff and saliva droplets from falling on the surgical field and thus the possibility of wound infection.

Recent literature demonstrates the efficacy of the aforementioned systems for surgeon's protection (e.g.: International Orthopaedics 2022, “The use of a surgical helmet system with a high-efficiency particulate air filter as possible protection equipment during the coronavirus disease 2019 pandemic: a double-blinded randomized control study”, G. Gasparini et al, https://doi.org/10.1007/s00264-022-05371-8).

In addition, it has long been highlighted that the toga-type garment offers considerable advantages compared to classic surgical gowns worn above a separate hood. In particular, the toga allows a correct evacuation of the exhausted air coming from the surgeon's breathing by means of the helmet's ducts, with no dispersion in the surrounding environment through the gap between the hood and the gown. Moreover, thanks to the posterior closure the toga makes the sterility of the surgeon's back safer. This latter aspect is very relevant, because often behind the surgeon there is a nurse with a servant table for sterile surgical instruments.

A technical disadvantage of the toga is that—being a single piece hood plus gown-when the surgeon moves, e.g. by raising and lowering the head or even more by turning the head to one side or the other, the toga tends to pull on the surgical helmet, with the risk of making it move or, worse, slip from the surgeon's head.

The exemplary representation in FIG. 1 allows getting an idea of the amount of displacement potentially involved by the operator's movements, as specifically associated with the position of the head. In particular, the distance AB between the manubrium of the sternum and the chin segment in a subject with body height of about 175 cm changes as follows:
head in surgical position (looking downwards at the surgical field)—AB=8 cm;
head in normal anatomical position (gaze forward)—AB=13 cm;
head rotated sideways of 90 deg about a vertical axis—AB =20 cm.

To minimize this problem, manufacturers tend to oversize the quantity of fabric in the neck and head area of the toga, so as to have enough excess fabric to avoid the problem described. (Excessively) oversizing the fabric, however, entails some relevant disadvantages. In particular:
it increases the encumbrance of the head portion and consequently makes correct illumination of the operating field more difficult, because the surgical field illumination lamp is normally located above the surgeon's head;
it can determine misplacement of selected parts of the hood portion, e.g. by bringing an air filtering part intended to cover the back of the helmet in a frontal position, so decreasing the protective barrier properties of the hood portion and of the protection system in general;
the aforementioned augmented encumbrance of the garment may slow down the surgeon's movements and expose the hood to possible contamination from touching surfaces close to the surgeon's head.

### SUMMARY OF THE INVENTION

The technical problem underlying the present invention is therefore to overcome one or more of the drawbacks mentioned above with reference to the state of the art.

The above problem is solved by a medical garment according to claim 1.

Preferred features of the invention are object of the dependent claims.

The invention provides a toga garment with improved torsional performances.

As mentioned with reference to the prior art, a toga garment is a garment covering at least both the head and torso of the user with a single piece of clothing. Therefore, the toga has a hood portion configured to cover the medical operator's head wearing a surgical helmet, and a gown portion configured to cover the operator's torso and preferably also part of the thighs, as for the known-art medical gowns.

At the connection of said two portions, e.g. in the region of the garment intended to cover the operator's neck and/or shoulders, a “twist” construction is provided, namely a structure which is deformable to adapt to a rotation of the user's head or body about a garment longitudinal axis, corresponding to a longitudinal body axis lying on the sagittal and frontal plane.

In other words, when the medical operator rotates the head about said axis, the connecting deformable structure stretches in order to avoid any misplacement or pull action by the garment. When the operator's head comes back to a central, anatomical position, the deformable structure returns in its initial unstretched configuration.

The above construction confers greater elasticity of the toga garment. It also allows the surgeon's head to move easily without encountering any resistance from the garment.

According to a preferred embodiment, the aforementioned deformable structure of the toga is obtained as a connecting fabric piece interposed between the upper part of the toga, i.e. the hood portion, and the lower part, i.e. the gown portion. Advantageously, such structure has a pleated construction, in particular with a plurality of folds parallel to said longitudinal axis.

According to a preferred embodiment, the pleated fabric is electrowelded to the lower part of the hood portion, in particular under the chin guard of the helmet and under the chin of the surgeon. The same fabric may also include a flat, i.e. non-pleated part, applied at the user's chest and therein connected to the gown portion of the garment.

According to a variant embodiment, the deformable structure is made, or includes, a filtering material, in particular a filtering fabric, in order to facilitate the exchange of air in the helmet.

In this construction, the deformable part may include a filtering material that is covered at selection regions, e.g. at the region to be joined to the upper hood portion, by a strip of protective fabric, e.g. to ease connection, particularly in case of electro-welding. Such protective fabric may be applied, e.g., in the area under the chin guard.

According to a variant embodiment, a deformable structure of the type described above can be applied at an intermediate region of the gown portion, e.g. in the hip area, for allowing freer rotational movements of the operator's torso. These latter movements are needed, e.g., for grasping instruments or in hip dislocations.

Other advantages, features and use modes of the present invention will result evident from the following detailed description of some embodiments, provided by way of example and not with limitative purpose.

### BRIEF DESCRIPTION OF THE DRAWINGS

Reference will be made to the figures of the annexed drawings, wherein:

FIG. 1, already introduced above, shows an exemplary frontal representation of part of the human head, neck and shoulder regions;

FIG. 2 is an exemplary representation of reference planes as associated with a human body in a standing anatomic position;

FIG. 3 is a schematic pictorial frontal representation of a medical operator in a standing position wearing a medical garment according to a preferred embodiment of the present invention;

FIG. 4 is a schematic pictorial lateral representation of a medical operator in a standing position wearing a medical garment according to another preferred embodiment of the present invention;

FIG. 5 is a posterior perspective view of an exemplary surgical helmet that can be worn below the medical garment according to embodiments of the present invention.

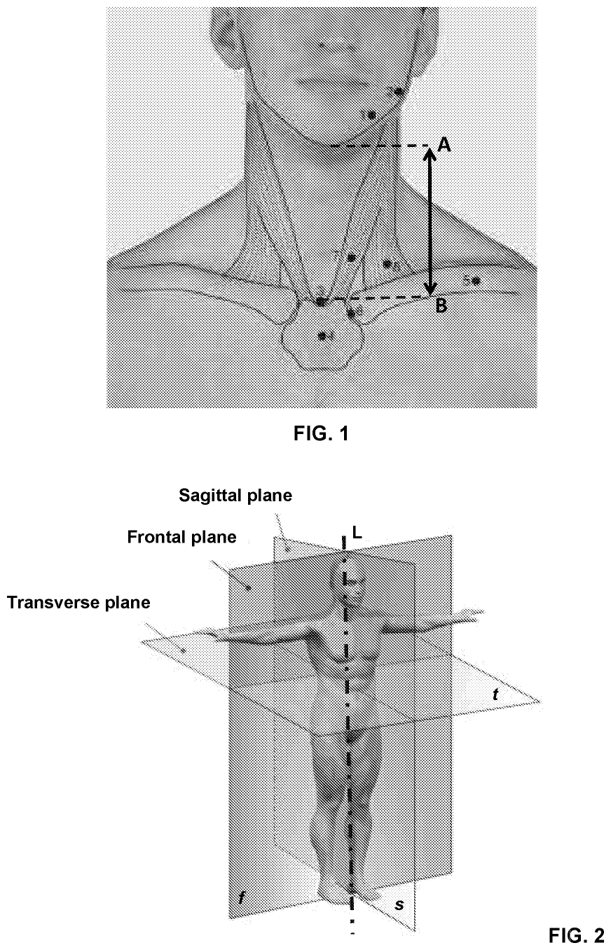

### DETAILED DESCRIPTION OF PREFERRED EMBODIMENTS OF THE INVENTION

Embodiments and variants of the invention will be described below, with main reference to the figures introduced above. In the following detailed description, additional embodiments and variants with respect to embodiments and variants already explained in the same description will be disclosed only in conjunction with the differences with respect to what has already been described. Moreover, the various embodiments and variants described hereinafter, as well as the relative components, means and elements, can be used in combination, when compatible.

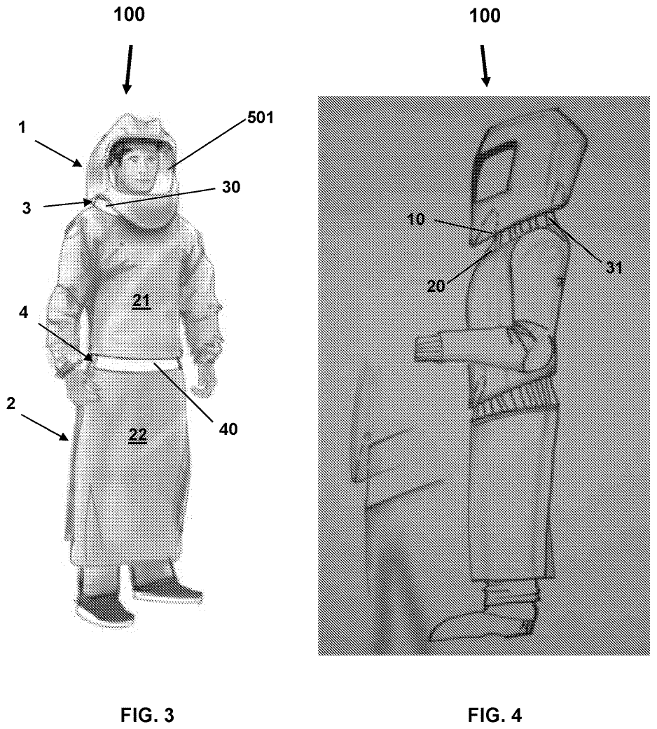

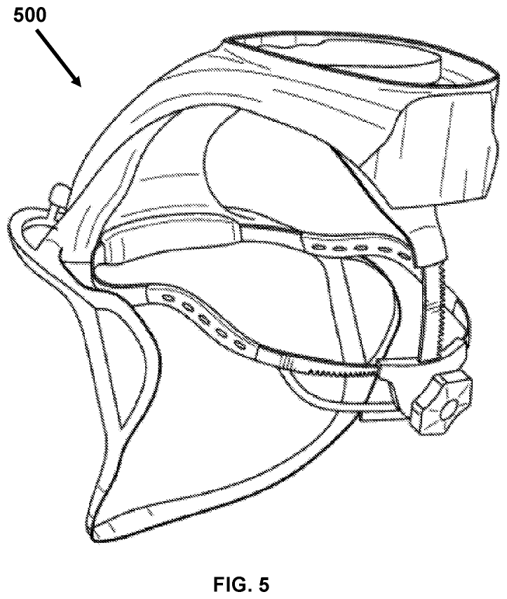

FIGS. 3 and 4 show, in a schematic and pictorial way, embodiments of a medical garment according to the invention, which garment is denoted by 100 in both figures. Garment 100 is configured to protect a medical operator from contamination during medical activities, in particular surgery.

FIG. 5 shows a known-art helmet, denoted by 500, that can be worn with garment 100.

As said above, FIG. 2 is a schematic representation of the reference body planes usually adopted in the medical field, namely a sagittal plane s, a frontal plane f and a transverse plane t. In the description that follows, the associated geometric definitions and references will be attributed to the garment and helmet in the intended configuration when worn by a user.

The medical garment 100 comprises mainly:
an upper hood portion 1, configured to cover the user's head and to be worn above surgical helmet 500;
a lower gown portion 2, configured to cover user's torso, including the abdomen, as well as the thighs and parts of the legs;
a first intermediate connecting portion 3 arranged between the hood portion 1 and the gown portion 2, in particular extending at a neck portion of garment 100; and
a second intermediate connecting portion 4 arranged at the lower gown portion 2 and connecting two adjacent sub-portions 21 and 22 thereof, in particular extending at a hip portion of garment 100.

The first and the second intermediate connecting portions 3 and 4 include each a respective torsionally deformable structure, denoted by 30 and 40, respectively, configured to ease the user's body rotation about a longitudinal axis L. The latter substantially corresponds to the intersection between frontal plane f and sagittal plane s.

In particular, the first torsionally deformable structure 30 is intended to facilitate rotation of the user's head and the second structure 40 rotation of the user's torso.

In the present example, the first structure 30 extends, and implements, the entire connecting portion 3. The same may apply to the second structure 40 in conjunction with the respective connecting portion 4.

Other embodiments may provide that the first and/or the second deformable structure 30, 40 extend, and/or implement, only a sub-region of the respective connecting portion 3, 4.

Still according to a preferred embodiment, the first connecting portion 3 is interposed between the respective adjacent garment portions 1 and 2 along an entire peripheral region 10, 20 of each of them. In other words, the upper hood portion 1 and the lower gown portion 2 are connected each other at their peripheral regions 10, 20 only by said intermediate connecting portion 3, not being in touch or structural continuity with each other.

According to a particular embodiment, the same may apply the second connecting portion 4 in conjunction with adjacent gown sub-portions 21 and 22.

Other embodiments may provide that the first and/or the second connecting portion 3, 4 extend only at part of the peripheral regions of the adjacent garment portions, the latter being also in direct connection with each other or joined also by other means not part of said connecting portions 3 and 4.

In the following, only the first connecting portion 3 and its structure 30 will be described in detail. It is understood that the same description applies, mutatis mutandis, to the second connecting portion 4 and its deformable structure 40.

Connecting portion 3 is in form of a transverse band circumscribing the user's body in a transverse plane.

In order to deform torsionally, the deformable structure 30 has a pleated construction, in particular including a plurality of folds 31, preferably parallel to each other, extending along a direction substantially parallel to the longitudinal axis L.

Intermediate connecting portion 3, and in particular its respective torsionally deformable structure 30, may include a filtering region configured to allow a selected exchange of air with the environment surrounding the medical garment 100.

As shown in FIG. 3, in the present embodiment the hood portion 1 includes an aperture, or window, receiving, or configured to receive, a frontal visor, or lens, 501 of a type known per se.

The present invention has been described so far with reference to preferred embodiments. It is intended that there may be other embodiments which refer to the same inventive concept as defined by the scope of the following claims.

1. A medical garment for protecting a medical operator from contamination, comprising:
an upper hood portion configured to cover the user's head and to be worn above a surgical helmet
a lower gown portion configured to cover at least the user's torso; and
a first intermediate connecting portion arranged between said hood portion and said gown portion which first connecting portion includes a torsionally deformable structure configured to ease the user's body rotation about a longitudinal axis.

2. The medical garment according to claim 1, further comprising a second intermediate connecting portion arranged at said lower gown portion and connecting two adjacent sub-portions of said lower gown portion, wherein said second connecting portion includes a torsionally deformable structure configured to ease the user's body rotation about a said longitudinal axis.

3. The medical garment according to claim 2, wherein said first torsionally deformable structure and/or said second torsionally deformable structure has a pleated construction.

4. The medical garment according to claim 2, wherein said first torsionally deformable structure or said second torsionally deformable structure comprises a plurality of folds along a direction substantially parallel to said longitudinal axis.

5. The medical garment according to claim 2, wherein said first intermediate connecting portion extends at a garment neck portion.

6. The medical garment according to claim 2, wherein said second intermediate connecting portion extends at a garment hip portion.

7. The medical garment according to claim 1, wherein said first intermediate connecting portion is interposed between said upper hood portion and lower gown portion along an entire peripheral region of each of them, so that said upper hood portion and lower gown portion are connected to each other at said perimetral regions only by said first intermediate connecting portion.

8. The medical garment according to claim 2, wherein said first torsionally deformable structure or said second torsionally deformable structure extends over the entire respective first intermediate connecting portion or second intermediate connecting portion.

9. The medical garment according to claim 2, wherein said first intermediate connecting portion or said second intermediate connecting portion, and in particular said respective torsionally deformable structure includes a filtering region configured to allow a selected exchange of air with the environment surrounding the medical garment.

10. The medical garment according to claim 2, wherein said first intermediate connecting portion or said second intermediate connecting portion is in form of a transverse band circumscribing the user's body in a transverse plane.

11. The medical garment according to claim 2, wherein said first intermediate connecting portion and/or said second intermediate connecting portion is made of fabric.

12. The medical garment according to claim 2, wherein said first connecting portion includes an upper deformable part adjacent to said hood portion and a lower flat part joined to said gown portion.

13. The medical garment according to claim 2, wherein said first connecting portion or said second connecting portion is joined to the adjacent garment portion by electro-welding.

14. A medical kit including a medical garment according to claim 1 and a surgical helmet to be worn underneath said medical garment.

15. A medical garment for protecting a medical operator from contamination, comprising:
a gown portion configured to cover at least the user's torso; and
an intermediate connecting portion arranged at gown portion and connecting two adjacent sub-portions of said gown portion, wherein said connecting portion includes a torsionally deformable structure configured to ease the user's body rotation about a longitudinal axis.

16. The medical garment according to claim 12, wherein said upper deformable part is a pleated part adjacent to said hood portion.
